(19) United States
(12) Patent Application Publication
(10) Pub. No.: US 2022/0332425 A1
(43) Pub. Date: Oct. 20, 2022

(54) AIRCRAFT PASSENGER SEAT UNIT AND ASSOCIATED CABIN ARRANGEMENT

(71) Applicant: AIRBUS ATLANTIC SAS, Rochefort (FR)

(72) Inventors: Olivier JÉRÔME, ROCHEFORT (FR); Benoît TRILLAUD, ROCHEFORT (FR)

(21) Appl. No.: 17/722,345

(22) Filed: Apr. 17, 2022

(30) Foreign Application Priority Data
Apr. 16, 2021 (FR) 2103964

(51) Int. Cl. B64D 11/06

(52) U.S. Cl. CPC B64D 11/0641; B64D 11/0606; B64D 11/0601; B64D 11/0605

(57) ABSTRACT

An airliner type aircraft passenger seat unit includes a seat that can be converted into a bed and a body isolating the seat from neighboring seats. The seat includes a seat section and a backrest that are movable. The body includes a rear partition, a side panel, on one side of the seat, and a console topped with a tray table, on the other side of the seat. The side panel and an outer wall of the console being parallel and spaced apart by a distance L between 1000 mm and 1600 mm. The passenger seat unit further includes a single motorized mechanism, to simultaneously actuate the movements of the seat section and the backrest, but remains capable of receiving one or more additional motorized mechanisms.

### TECHNICAL FIELD

The present invention belongs to the field of seats for passengers of transport vehicles, particularly of airliners, and relates more particularly an aircraft passenger seat unit and a cabin arrangement obtained with such units.

The present invention finds a direct application in the business class fittings of medium- or long-haul aircraft, without being restricted thereto.

### BACKGROUND OF THE INVENTION

In air transport, passenger comfort is an essential competitive component. For most airlines, this comfort is influenced by profitability and environmental impact reduction requirements, which result in high-density layouts, in other words, placing a maximum number of passengers in the space available for this purpose.

The level of comfort required in higher classes (first class and business class) must for example offer passengers the option to lie down in a reclined position, particularly when the flight time is long, and benefit from some privacy from other passengers.

Seats that can convert into beds have been known for a long time and exist in numerous configurations.

Aircraft passenger seats are subject to strict design constraints, many of which do not apply to seats from other vehicle types. One of the problems is the need to comply with the safety standards applicable to aircraft passenger seats, such as the 16 g test which requires that seats survive a 16 g deceleration in the takeoff/landing position. Another problem is the need to minimize the weight of the seat, as transporting an additional weight on an aircraft increases fuel consumption and therefore the monetary and environmental cost. Therefore, the seat must be both sturdy and lightweight.

Another problem relates to the use of space. All aircrafts have a maximum surface area for passenger seats, which must be used as efficiently as possible in order to maximize the seating surface area and legroom for each passenger, while enabling an unimpeded exit from the seat. It is also important, for cost reasons, to hold the greatest number of the passenger seats in the space available.

Another problem relates to the level of seat comfort. Aircraft passenger seats may be used for daytime flights, during which the passenger will wish to work, eat and/or relax, and for night-time flights, during which the passenger will wish to sleep. Preferably, a passenger seat should be capable of adopting comfortable positions for all these activities, while being capable of complying with the relevant safety standards in the takeoff/landing position.

Another problem relates to the psychological and/or social needs of the aircraft passengers, who may wish to have privacy while they work, eat or sleep, or who may wish to interact with a travelling companion. Certain arrangements are also undesirable for esthetic reasons; for example, it is preferable that certain parts of the seat mechanism cannot be seen by the passenger.

For business class seats, the passenger needs the highest possible level of comfort and it is accepted that the space available will be used to accommodate fewer passenger seats than for economy class. For sleeper seats, it is desirable to offer bedding that is as close as possible to a normal bed. However, normal single beds are considerably wider than an aircraft passenger seat should be.

As a general rule, the most comfortable passenger seats are reserved for long-haul aircraft (or jumbo jets) and are arranged in dense arrangements with transverse rows comprising four or more seats.

The relatively narrow cabins of medium-haul aircraft, particularly those of the single-aisle type, do not allow airlines to use identical seats to those used on long-haul aircraft.

Furthermore, convertible business class and first class seats include complex motorized mechanisms individually actuating each part of the seat, particularly the seat section and the backrest, which represent a certain mass and a certain cost, unsuitable for use in medium-haul aircraft of reduced cabin width.

### OBJECT AND SUMMARY OF THE INVENTION

The invention is aimed at remedying the drawbacks of the prior art described above and proposes a simple and economical solution, which is adapted both to cabins of long-haul aircraft (jumbo jets) and to cabins of medium-haul aircraft of the single-aisle type, while offering the same level of comfort for the passenger.

For this purpose, the present invention relates to a passenger seat unit of a means of transport such as an airliner, comprising a seat that can be converted into a bed and a body isolating said seat from neighboring seats, said seat including a seat section and backrest that are movable, said body comprising a rear partition, a side panel, on one side of the seat, and a console topped with a tray table, on the other side of the seat. This seat unit is remarkable in that the side panel and an outer wall of the console are parallel and spaced apart by a distance L between 1000 mm and 1600 mm.

This configuration renders the seat unit adaptable to long-haul and medium-haul aircraft, while retaining the same elements and conveniences. This is a considerable advantage over the solutions of the prior art wherein seat units have very different designs depending on the type of aircraft.

Advantageously, the seat unit comprises a single motorized mechanism to simultaneously actuate the movements of the seat section and the backrest of the seat, and remains capable of receiving one or more additional motorized mechanisms.

According to an embodiment, at least one transverse section contour is inscribed in a parallelogram, each side of said parallelogram being at least partially merged with a rectilinear part of said contour.

More specifically, the circumscribing parallelogram is not a rectangle.

According to an embodiment, the rectilinear parts belong respectively to the rear partition, to the side panel, to a free edge of the seat section and to the outer wall of the console.

Advantageously, the seat has a horizontal reclining surface formed by the seat section and the backrest, when said seat is in a reclined position, said reclining surface being capable of being extended by means of a side extension adjoined to the console and a height-adjustable armrest placed at the side panel.

The armrest has an axis substantially parallel with an axis of the seat, the latter being inclined in relation to the aircraft axis.

The invention also relates to an aircraft cabin seat arrangement, comprising a plurality of seat units as described.

According to an embodiment, the arrangement comprises two side groups and one central group in a herringbone (or angled) configuration.

According to another embodiment, the seat arrangement comprises only two side groups each including one seat unit per transverse row.

According to an advantageous embodiment, each seat unit has a distance L substantially equal to 1549.4 mm.

Finally, the invention further relates to a single-aisle type medium-haul airliner, comprising a seat arrangement as described.

As the fundamental concepts of the invention have been described above in the most basic form thereof, other details and features will emerge more clearly on reading the following description and with reference to the appended drawings, giving by way of non-limiting example an embodiment of a seat unit according to the principles of the invention.

### DESCRIPTION OF THE DRAWINGS

The figures are given merely by way of illustration for better comprehension of the invention without limiting the scope thereof. The different elements can be represented schematically and are not necessarily at the same scale. In all of the figures, identical or equivalent elements bear the same reference number.

Thus, the drawings illustrate in:

FIG. 1: a front perspective view, on the console side, of a seat unit according to an embodiment of the invention;

FIG. 2: a front perspective view, on the access side, of the seat unit;

FIG. 3: a rear perspective view of the seat unit, showing the ottoman;

FIG. 4: a top view of the seat unit;

FIG. 5: the seat unit inscribed in a parallelogram;

FIG. 6: the maximum reclining surface obtained with successive seat units;

FIG. 7: a top view of the seat unit with the folding tray deployed;

FIG. 8: two adjoined seat units of the central group of an arrangement according to an embodiment of the invention;

FIG. 9: a transverse row of a long-haul aircraft cabin arrangement;

FIG. 10: a transverse row of a single-aisle type medium-haul aircraft cabin arrangement;

FIG. 11: a rear perspective view of two successive seat units; and

FIG. 12: a front perspective view of two successive seat units.

### DETAILED DESCRIPTION OF EMBODIMENTS

It should be noted that some technical elements well-known to a person skilled in the art are described here to prevent any lack or ambiguity in the comprehension of the present invention.

In the embodiment described hereinafter, reference is made to an aircraft passenger seat unit, primarily intended for airliner business class fittings. This non-limiting example is given for better comprehension of the invention and does not exclude the use of an identical or similar unit in other suitable means of transport.

Hereinafter in the description, the term “body” denotes by extension a receiving structure extending behind the seat and laterally thereto, making it possible at the same time to isolate the seat from neighboring seats and receive various conveniences for the passengers comfort.

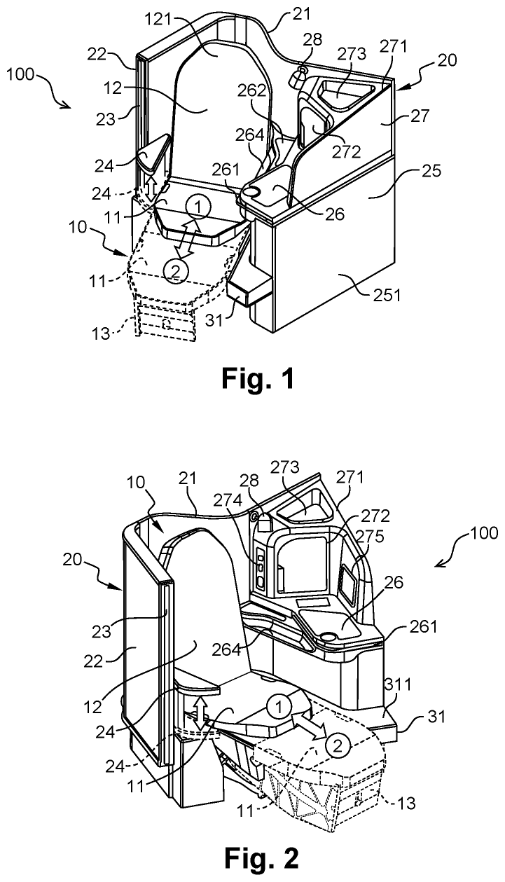

FIG. 1 represents a seat unit 100 comprising a seat 10 partially surrounded by a body 20 defining usable space for the passenger and comprising for this purpose different conveniences, as is customary in air transport.

The seat 10 essentially comprises a seat section 11 and a backrest 12, both movable in such a way that the seat 10 is convertible between a sitting position, wherein the backrest 12 is straightened and forms an angle substantially perpendicular with the seat section 11, and a reclining position wherein the backrest is folded back to be aligned with a midplane of the seat section 11 and thus form a substantially horizontal reclining surface acting as a bed for the passenger.

The seat 10 switches from the sitting position to the reclined position, and vice versa, continuously by means of a single motorized mechanism actuating both the seat section 11 and the backrest 12. Between these two positions, the seat 10 can optionally occupy at least one intermediate position such as a “relaxation” position wherein the backrest 12 is inclined in relation to the seat section 11 by a more or less substantial obtuse angle.

Preferably and for simpler kinematics, the seat 10 does not occupy any intermediate position between the sitting position and the reclined position.

During a transition from the sitting position to the reclined position, the movement of the seat section 11 is essentially a forward translation, from position 1 to position 2 as shown in FIG. 1, whereas the movement of the backrest 12 is composed of a curvilinear downward translation and a rotation. Obviously, the reverse transition is accompanied by reverse respective movements.

The seat 10 can have any shape, preferably this shape is optimized to occupy the space available and provide the passenger with the comfort needed. In the example illustrated, the seat section 11 and the backrest 12 have beveled free edges. This shape is particularly adapted to receive a headrest at a top part 121 of the backrest 12. The headrest can be fixed or removable to allow the passenger the freedom to remove it in the reclined position.

The seat 10 further includes a cover 13 under the seat section 11 to conceal elements of undesirable appearance such as the motorized conversion mechanism, lower structural elements, fastenings, etc.

The seat 10 is disposed inside the body 20 which is designed to be adapted to the different positions of said seat and to isolate said seat from neighboring seats in a cabin arrangement comprising a plurality of units 100.

The body 20, of complex structure, includes a rear partition 21 extending laterally to the seat 10 by a side panel 22, a sliding door 23 arranged inside the side panel, an adjustable armrest 24 located on the side of said side panel, a console 25 on the other side of the seat topped with a cocktail tray table 26 and a functional assembly 27 for storing and controlling the seat 10.

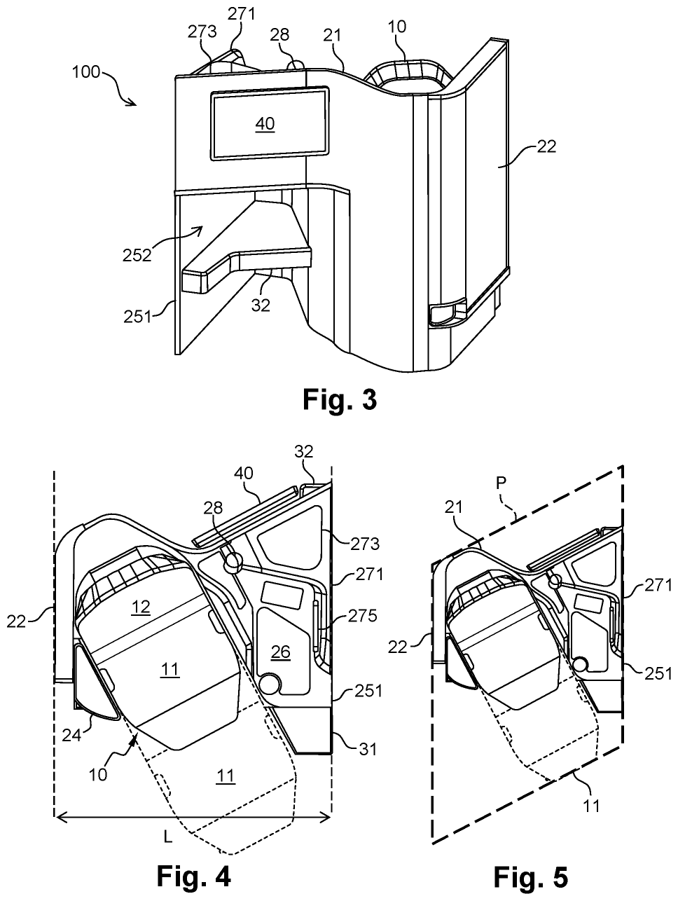

The rear partition 21, according to the embodiment example illustrated, has a planar part adapted to receive a screen 40 which is used for the passenger of a seat unit placed immediately behind the unit in question, as shown in FIG. 3, and a curved part acting as a junction between said planar part and the side panel 22.

The side panel 22 has a thickness greater than that of the rear partition 21 to receive the sliding door 23 and a height equal to that of said partition and sufficient to ensure the passengers privacy in the sitting position.

The sliding door 23 preferable makes it possible to completely close the passage between two successive seat units 100. For this reason, when it is entirely closed, the sliding door 23 of a seat unit 100 is flush with the side panel 22 of the next seat unit.

The armrest 24 is height-adjustable as shown by the two-way arrow in FIGS. 1 and 2. This adjustment enables the passenger to use the armrest 24 in the primary function thereof in the sitting position, in which case said armrest is located in the high position, but also as an extension of the reclining surface in the reclined position, in which case the armrest in located in the low position.

On the opposite side, the passenger also has a second armrest in the form of a recess 264 formed in the structure of the cocktail tray table 26.

The console 25, according to the embodiment example illustrated, has a shape which, internally, globally molds the shape of the seat 10 and, externally, adapts to the position of the seat unit 100 in the cabin arrangement. For this purpose, the console 25 is delimited by a planar outer wall 251 to adjoin easily either to the outer wall of an adjacent identical seat unit in a central group of the cabin arrangement, or to the inner wall of the fuselage when the unit belongs to a side group of the cabin arrangement. The possible cabin arrangements are described hereinafter in the present description.

The cocktail tray table 26 essentially comprises a folding tray 261 and slots 262 for the passenger to place different objects.

FIG. 7 represents in a top view the folding tray 261 deployed from the housing thereof, said tray being rotatable in relation to an off-center axis perpendicular to the plane of the tray table 26.

The functional assembly 27, according to the embodiment example illustrated, is delimited externally by a planar wall 271 substantially coplanar with the outer wall 251 of the console 25, and comprises a closed compartment 272 capable for example of receiving a minibar, an open compartment 273 to place the passengers various personal belongings, a control center 274 for example for adjusting the position of the seat 10 and a touchscreen 275 for displaying the flight data for example.

Obviously, the functional assembly 27 can be arranged differently.

The body 20 can further include other equipment such as a personal lighting device 28 such as a reading or background light.

The seat unit 100 also includes a side extension 31 adjoined to the console 25 to extend the reclining surface when the seat 10 is in the reclined position. Indeed, the side extension 31 has a top surface 311 located substantially at the same level as the reclining surface obtained by the movable elements of the seat 10, i.e., the seat section 11 and the backrest 12.

With reference to FIG. 3, the seat unit 100 includes an ottoman 32 placed to the rear of the body 20 in an internal volume 252 of the console 25, so as to form an extension of the reclining surface of the seat of the seat unit immediately behind, on which extension the passenger behind can at least place their feet.

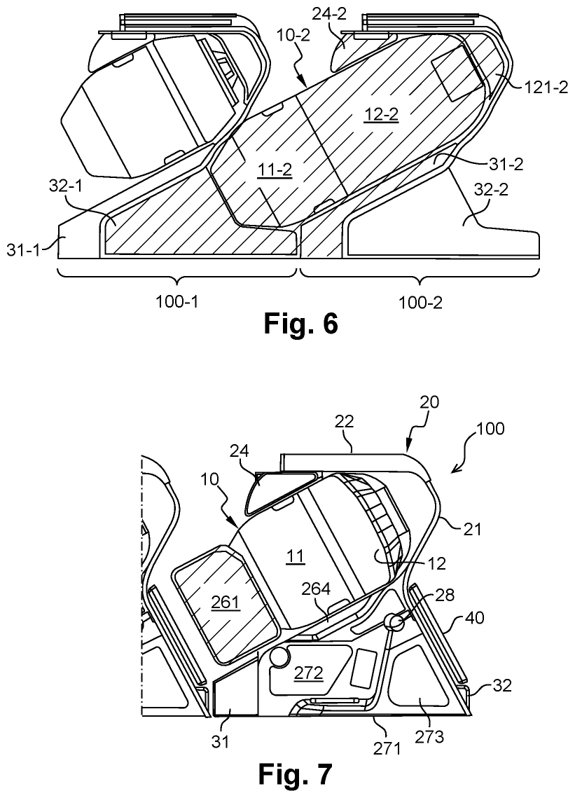

FIG. 6 represents the maximum reclining surface that can be obtained with two successive seat units, a front unit 100-1 and a rear unit 100-2. This reclining surface, represented with widely spaced hatching, is available for the passenger of the seat behind 10-2 and comprises the seat section 11-2 and the backrest 12-2, with its headrest 121-2, of said seat behind, the armrest 24-2 and the side extension 31-2 of the rear unit, as well as the ottoman 31-1 of the front unit.

The seat unit 100 thus provides the passenger with the comfort needed while being compact and not bulky. This gives it the advantage of adapting to aircraft of different sizes, particularly long-haul aircraft such as the Airbus A350 and single-aisle type medium-haul aircraft such as the Airbus A320.

FIG. 4 represents a top view of the seat unit 100 to show the parallelism between the plane of the side panel 22 and the common plane of the outer walls 251 and 271, these two planes being represented with a dotted line. This configuration enables the seat unit 100 to occupy transversely the shortest distance with a width L, for example, between 1000 mm and 1550 mm, preferably between 1016 mm (or 40″) and 1549.4 mm (or 61″) inclusive.

In order to maintain a reduced footprint (surface area occupied on the cabin floor) while optimizing the arrangement of the seat unit in a “high-density” arrangement, the seat unit 100 is inscribed in a parallelogram P, as shown in FIG. 5. More specifically, the seat unit 100 has a longer contour in transverse cross-section inscribed in a parallelogram.

In a three-dimensional representation, this is shown in that the seat unit 100 is contained in a parallelepiped, having as a cross-section the parallelogram P, while being perfectly adjacent to each of the lateral faces of said parallelepiped.

Preferably, the side panel 22 and the outer walls 251 and 271 are contained, completely or partially in opposite faces of the parallelepiped, while the free edge of the seat section 11 and a part of the rear partition 21, located just behind the backrest, are contained, completely or partially, in the other opposite faces of the parallelepiped.

Obviously, due to the obliqueness of the seat 10 in relation to the body 20 (the axis of the seat being inclined in relation to the longitudinal axis of the body), the circumscribing parallelogram P is not a rectangle.

The above geometric characteristics render the seat unit 100 particularly adapted both to conventional business class arrangements in long-haul aircraft (jumbo jets) and to narrower arrangements on single-aisle type medium-haul aircraft.

In the first case, a central group can be formed by adjoining seat units 100 pairwise according to a reflection (mirror) symmetry.

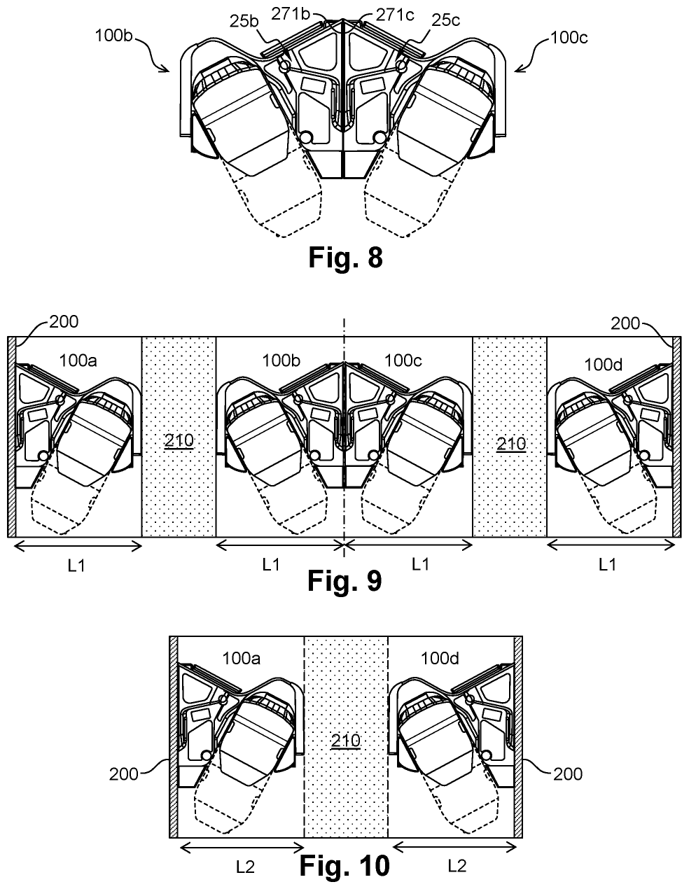

FIG. 8 represents a first, so-called left, seat unit 100b, and a second, so-called right, seat unit 100c, adjoined at the consoles 25b and 25c thereof such that the outer walls 271b and 271c are also adjoined. Thus, the two consoles are well separated and isolated from one another unlike the solutions of the prior art providing a common central console.

It should be noted that the units 100b and 100c are identical apart from a symmetry. Indeed, in the left unit 100b, the console 25b is located to the left of a passenger of the seat of said unit, while in the right unit 100c, the console 25c is located to the right of a passenger of the seat of said unit.

The central group thus obtained can be placed between two side groups in a jumbo jet cabin.

FIG. 9 represents a transverse row of such an arrangement. The latter comprises two side groups adjoined to the fuselage 200 and a central group separated from each of said side groups by a passageway 210.

Each side group comprises one seat unit for each transverse row, such that the number of seat units per transverse row is equal to four units. Indeed, each transverse row in a jumbo jet arrangement comprises a first unit 100a, a second unit 100b, a third unit 100c identical to the first unit, and a fourth unit 100d identical to the third unit, so as to obtain a configuration A-BA-B.

Per se, the arrangement in FIG. 9 is a herringbone arrangement known in the art.

However, the seat unit 100 according to the present invention also remains perfectly adapted to a narrower arrangement intended for single-aisle type aircraft wherein the airlines do not usually provide such a level of comfort.

FIG. 10 represents a transverse row of a single-aisle aircraft cabin arrangement, only comprising two side groups with no central group. The side groups are each adjoined to the fuselage 200 and separated from one another by a passageway 210. In a transverse row, each side group comprises a single seat unit.

Thus, each transverse row comprises a first unit 100a and a second unit 100d that are symmetrical in relation to a median longitudinal plane of the cabin.

In the light of the difference in width between cabins, the seat units intended for jumbo jets have a width L1 and the seat units intended for single-aisle aircraft have a width L2 preferably greater than L1, obviously thanks to a compromise between comfort and mass.

Regardless of the arrangement, the seats are all oriented away from the adjacent passageways for more peace and less distraction by the passage of passengers and crew. Thus, the seats of the side groups are oriented toward the fuselage and the seats of the central group are oriented toward the central cabin axis.

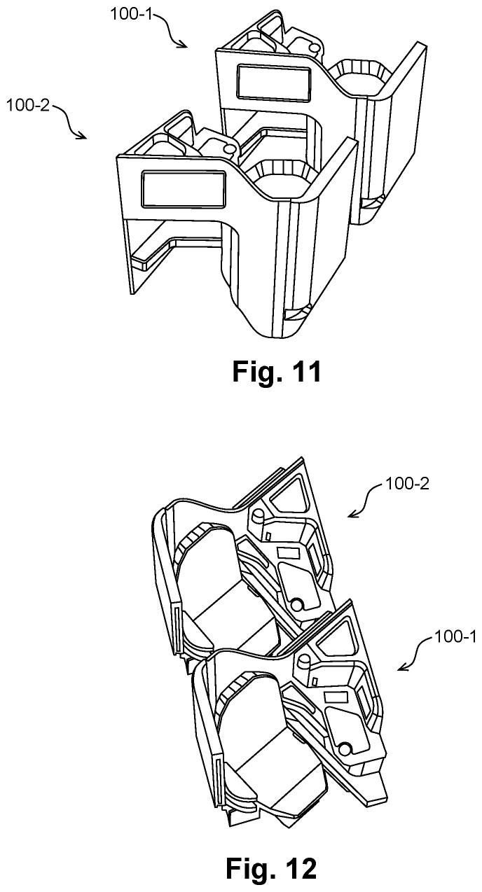

In each side or central group of the arrangement, the units 100-1 and 100-2 of successive transverse rows are arranged in relation to one another as shown in FIGS. 11 and 12.

It is clear from the present description that some elements of the seat unit can be modified, replaced or removed and that some adjustments can be made to the arrangements thereof, without leaving the scope of the invention.

1-17. (canceled)

12. A seat unit for a passenger of an airliner, comprising:
a seat that can be converted into a bed and a body isolating the seat from neighboring seats, the seat comprising a seat section and a backrest that are movable, the body comprising a rear partition, a side panel, on one side of the seat, and a console topped with a tray table, on the other side of the seat;
a single motorized mechanism to simultaneously actuate the movements of the seat section and the backrest of the seat; and
wherein the seat unit is configured to receive one or more additional motorized mechanisms.

13. The seat unit of claim 12, wherein the side panel and an outer wall of the console are parallel and spaced apart by a distance L between 1000 mm and 1600 mm.

14. The seat unit of claim 12, wherein at least one transverse section contour is inscribed in a circumscribing parallelogram, each side of the circumscribing parallelogram being at least partially merged with a rectilinear part of said contour.

15. The seat unit of claim 14, wherein the circumscribing parallelogram is not a rectangle.

16. The seat unit of claim 14, wherein the rectilinear parts belong respectively to the rear partition, to the side panel, to a free edge of the seat section and to the outer wall of the console.

17. The seat unit of claim 12, wherein the seat has a horizontal reclining surface formed by the seat section and the backrest, when said seat is in a reclined position, said horizontal reclining surface being extendible by a side extension adjoined to the console and a height-adjustable armrest placed at the side panel.

18. An aircraft cabin seat arrangement comprising a plurality of seat units of claim 12.

19. The seat arrangement of claim 18, comprising two side groups and one group in a herringbone configuration.

20. The seat arrangement of claim 18, comprising only two side groups, each sid group comprising one seat unit per transverse row.

21. The seat arrangement of claim 20, wherein each seat unit has a distance L substantially equal to 1549.4 mm.

22. A single-aisle medium-haul airliner, comprising a seat arrangement of claim 20.
